(19) United States
(12) Patent Application Publication
(10) Pub. No.: US 2012/0030279 A1
(43) Pub. Date: Feb. 2, 2012

(54) Systems and Methods for Enabling Places and Objects with Virtual Services

(76) Inventor: Tamer S. Rizk, Cambridge, MA (US)

(21) Appl. No.: 13/085,904

(22) Filed: Apr. 13, 2011

Related U.S. Application Data
(60) Provisional application No. 61/369,773, filed on Aug. 2, 2010.

(51) Int. Cl. G06F 15/16

(52) U.S. Cl. 709/203

(57) ABSTRACT

Systems and methods for enabling places and objects with virtual services are provided. Using an application a user may register a geographical location and electronically control information and services disseminated from the geographical location to other users, based on variables such as proximity and privilege. The system maintains a mapping between geographical locations and content sources such that geographical locations may be translated to content sources for users and users may interact with virtual services provided by the location.

### CROSS REFERENCE TO RELATED APPLICATIONS

This application claims priority from U.S. Provisional Application Ser. No. 61/369,773 filed on Aug. 2, 2010, the entirety of which is herein incorporated by reference.

### FIELD OF THE INVENTION

The invention generally relates to the fields of computer systems, mobile devices, mobile and internet communications, mobile and web applications, location services and most specifically relates to the field of mobile geo-interaction.

### BACKGROUND OF THE INVENTION

Throughout the past few decades, the need to make information and services available has diversified beyond the geographical proximity of the source of the information or service. In the past, entities have enabled the communication of information and services within geographic proximity using human resources, custom built machines, and printed media. Now, businesses enable services for their prospects or customers remotely via the Internet, telephone or television. Individuals facilitate communication with friends, family and acquaintances using telephone and Internet via services such as online social networks, video, chat, and forums. The recent growth in adoption of mobile devices enabled with location services and mobile applications predict an exciting evolution of geocentric communication.

The Internet is the worldwide, publicly accessible network of interconnected computer networks that transmit data by packet switching using the standard Internet Protocol (IP). It is a “network of networks” that consists of millions of smaller domestic, academic, business, and government networks, which together carry various information and services, such as electronic mail, digital video, online chat, file transfer, and the interlinked Web pages and other documents of the World Wide Web.

The World Wide Web (“Web”) is a global, read-write information space. Text documents, images, multimedia and many other items of information, referred to as resources, are identified by short, unique, global identifiers called Uniform Resource Identifiers (URIs) so that each can be found, accessed and cross referenced in the simplest possible way. The Web has been used in industry as a means of communication to facilitate business and social transactions.

The Web allows users to jump from content located on one server to alternate content located on either the same server or another server by selecting a word or picture (a “hyperlink”) that references information the user wishes to acquire. A user utilizes a navigation program, called a “Web browser” (“browser”) to traverse the hyperlinks on the Web and hence navigate content. Some examples of common Web browsers include Microsoft Internet Explorer, Mozilla Firefox, Google Chrome, Apple Safari and Opera.

The model of accessing content on the Web has evolved to support full-fledged, feature rich, hosted web applications that are accessed over a network such as the Internet or an intranet. Web applications are typically coded in a browser-supported language, such as JavaScript, combined with a browser-rendered markup language, such as HTML, and reliant on a common web browser to render the application executable. To enable intensive logic, processing, and state, web applications often make use of server-side programming in languages such as PHP, Python, Perl, Java, and ASP as well as data systems such as MySQL, PostgreSQL, Oracle, and MSSQL.

The Mobile Web refers to the use of Internet-connected applications, or browser-based access to the Internet from a mobile device, such as a smartphone or tablet PC, connected to a wireless network. In 2008 an important milestone in the transition from fixed to mobile Web use was reached when mobile access to the Internet exceeded desktop computer-based access for the first time. As mobile devices are evolving with computing capacity close to traditional computers, mobile applications are also evolving resembling their web counterparts augmented with mobile features such as location. In fact, a large number of mobile applications are actually web applications accessed within a mobile browser connected to the Internet.

Currently the trend of mobile location based applications and services revolve around “checking in” to a location, viewing location details, such as who else might be there, finding friends, and perhaps posting multimedia messages. Location owners have limited control over the application as opposed to the level of control they might have over their own website. There is no standardized and convenient method to access a mobile application belonging to a location or object. Either users are forced to install a specific application or the application is accessed using its URL rather than its location.

A virtual services mechanism for locations and objects is provided in the present invention as a system and method for enabling places and objects with virtual services. Additional features and advantages of the invention will be made apparent from the following detailed description of an illustrated embodiment which proceeds with a summary of the invention and reference to the accompanying drawings.

### SUMMARY OF THE INVENTION

It is therefore the objective of the present invention to provide a system and method for creating and accessing virtual services related to moving or fixed geographical locations through a communication medium having a client-server architecture, such as the Mobile Web. To achieve this and other objectives, there is provided, in accordance with the invention, methods for the registration, display, control, and end-user utilization of virtual services for locations and objects. A location or object enabled with virtual services is hereafter known as a Presence.

The method of Presence registration commences with the specification of a geographical region where the Presence is located. Other parameters may also be specified, such as, but not limited to a name, a category, a description, URLs and other metadata for the Presence. Specification of the geographical region may occur via a computer or mobile device and may utilize GPS coordinates, altitude, a radius describing the Presence proximity, or any other location notation methodology with any input method, manual or automatic. Similarly the metadata input may occur via computer, laptop, tablet or mobile device and may utilize any method, manual or automatic, such as plain text, form fields, XML, or URL encoded variables. The location and metadata are primarily stored on one or more remote servers that collect and disseminate this type of data for many Presences.

The method of display may be characterized by a client-server architecture where a client requests Presence data for a specific Presence from a server or servers based on an identifier or identifiers such as a unique system generated ID, the Presence name, its coordinates, URL or IP address. A user interface is provided, including means for allowing a user to select the Presence. The user interface is preferably a graphical user interface (GUI), but may also be an Applications Programming Interface (API) or a text console. The Presence may be chosen from a list of Presences returned by searching for Presences by parameters such as coordinates, geographical radius, name, category, URL, IP address or keywords. The Presence data returned by the server to the client may be parsed and formatted by the client or may be utilized to locate and direct the client to the Presence resource such as a file, multimedia, web application, mobile application or website.

The method of control is summarized by an owner or manager of a Presence editing the Presence location or metadata and managing the delivery of virtual services; including communication with, access to, appearance of, and functionality available to end-users. The owner or manager may control the Presence using a control interface that is a Graphical User Interface (GUI), an Applications Programming Interface (API) or a text console via a computer or mobile device. The control interface may be a file, program, web application, mobile application or website and may be defined as a Presence interaction control interface if specified by the Presence owner or manager as a file path, resource ID, URL or IP address within the metadata during Presence registration or control. The Presence control interface may be private to the owner or manager and may not be accessible to the end-users or public.

The method of utilization typically varies between the Presence owner or manager and the Presence end-users or public. The Presence owner or manager will control the Presence using a control interface as described above, in addition to utilizing the Presence as an end-user. Utilization of the Presence by end-users or the public is characterized by displaying the Presence as mentioned above and interacting with the Presence through an end-user interface.

The end-user interface is a Graphical User Interface (GUI), an Applications Programming Interface (API) or a text console accessed via a computer, laptop, tablet or mobile device. The end-user interface may be a file, program, web application, mobile application or website and may defined as a Presence end-user interaction interface if specified by the Presence owner or manager as a file path, resource ID, URL or IP address during Presence registration or control. The end-user uses the end-user interface to submit commands and requests to the Presence which are executed by the Presence software. The Presence software is typically hosted on a server or servers, local or remote. The response to a command or request, generated by the Presence software, may be parsed and formatted by the client or may be utilized to locate and direct the client to a Presence resource such as a file, multimedia, web application, mobile application or website.

### BRIEF DESCRIPTION OF DRAWINGS

FIG. 1: Smartphones and computers capable of incorporating the invention.

FIG. 2: A system diagram of a typical computer network, including the Internet, to connect clients to servers; the client and server systems being capable of incorporating the invention.

FIG. 3: A high level flow chart of Presence registration.

FIG. 4: A diagram of a Presence registration screen.

FIG. 5: Documentation on Presence registration.

FIG. 6: A diagram of an owner/manager Presence selection interface.

FIG. 7: A diagram of an end-user Presence selection interface.

FIG. 8: A high level flow chart of Presence control.

FIG. 9: A diagram of a Presence edit screen.

FIG. 10: A diagram of a Presence interaction control interface.

FIG. 11: Documentation on Presence control.

FIG. 12: A high level flow chart of Presence access.

FIG. 13: An example algorithm to access a Presence.

FIG. 14: Diagrams of formatted end-user view screens.

FIG. 15: A diagram of a Presence end-user interaction interface.

### DESCRIPTION OF THE PREFERRED EMBODIMENT

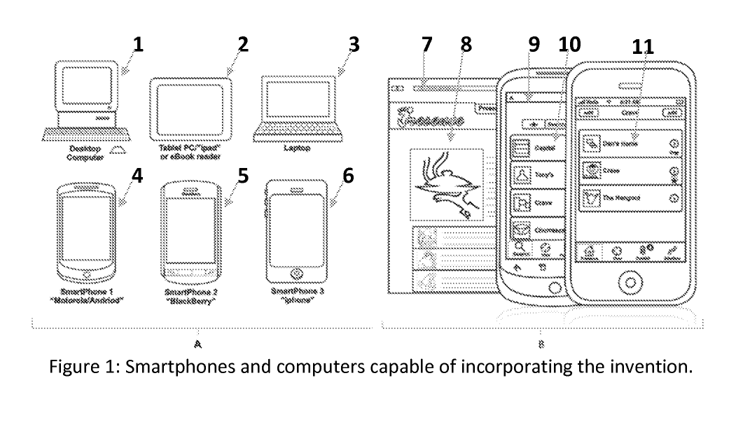

FIG. 1A illustrates typical client devices, a computer (1), tablet PC (2), laptop (3) and array of mobile phones (4, 5, 6) each of which may incorporate the invention. In FIG. 1B, the program (8, 10, 11) run by the client (1-6) incorporating the invention may be provided by means of a commercial computer program product such as a web browser (7, 9) or a pre-programmed native application (11). In the case of a web browser (7, 9), the novel and non-obvious features of the invention are interpreted or otherwise processed from program code stored locally on the device or retrieved from a remote server. In the case of a native application (11), the novel and non-obvious features of the invention are preprogrammed for convenient sales and marketing. In either case, the program (8, 10, 11) run by the client (1-6) directs the operation of the client device in accordance with the invention.

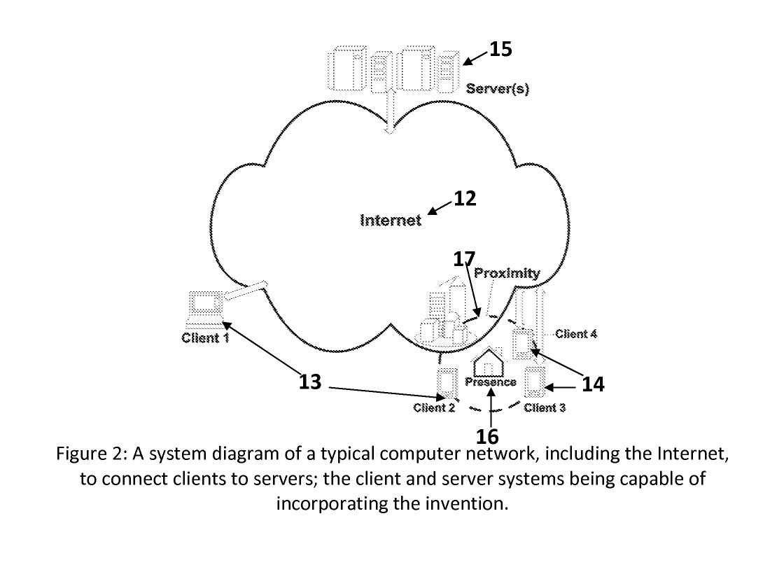

FIG. 2 illustrates a typical communication and processing network, utilizing the Internet (12) to make up an information delivery system consisting of a typical combination of resources including clients (13, 14) which may be of any suitable device (1-6), servers (15), and communication links. Various nodes are coupled to one another by various networks which may include local area networks (LANs), wide area networks (WANs), etc.

The program run by the servers (15), which may incorporate the invention, and may be provided to a general purpose computer on a pre-recorded medium or over the Internet, in which cases the novel and non-obvious features of the program code are pre-programmed, directs the operation of a server machine (15) in accordance with the invention.

The clients (13, 14) are coupled, through a communication network (12) such as the Internet, to the servers (15) through any enabling connection technology such as Fiber, Ethernet, WiFi, WiMax, 2G, 3G, 4G, etc. The general command protocols, etc., for exchanging messages between the clients (13, 14) and the servers (15) are conventional.

The communication between the clients (13, 14) and the servers (15) result in the fixed or moving location or object (16) being established as a Presence capable of implementing virtual services and virtual services management within a proximity (17) of any radius.

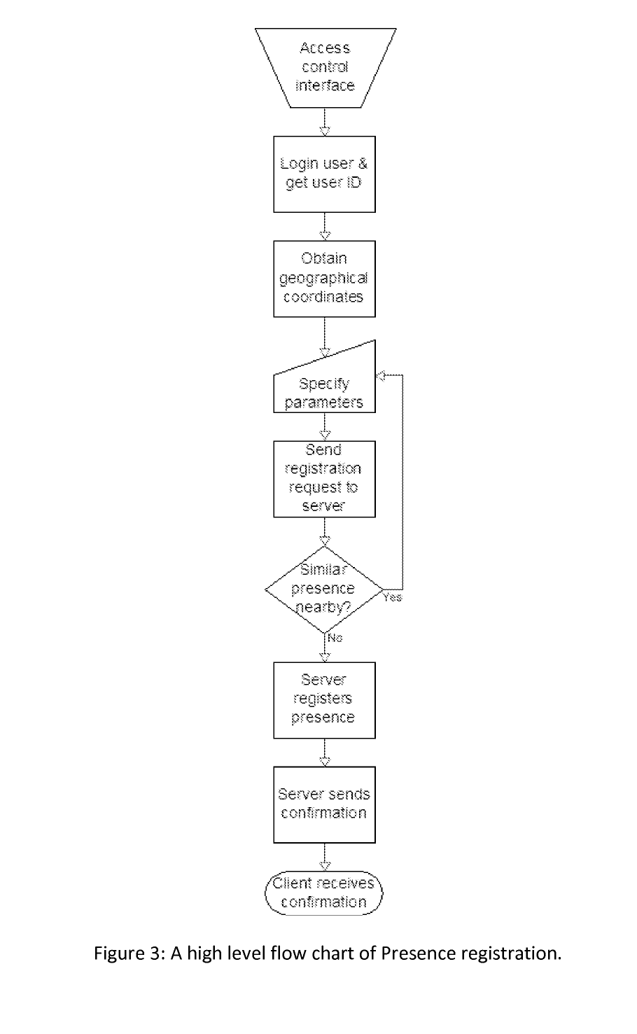

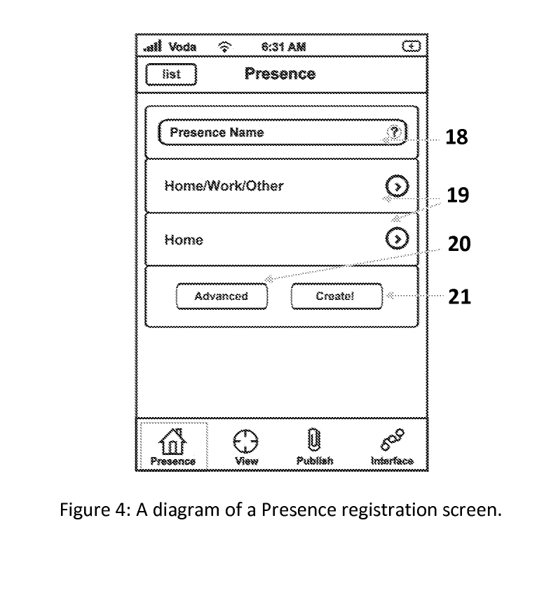

FIG. 3 is a high level flowchart showing one method of generating or registering the Presence (16) using a control interface of the program (8, 10, 11). FIG. 4 graphically illustrates the Presence registration screen of the control interface. A client (13) accesses the control interface to register (23) a Presence. The client is logged in with the server (15) and a pre-generated system user ID is obtained. In the preferred embodiment, the location of the Presence is automatically obtained using the GPS coordinates of the device (13 client 2), however it should be apparent that in the case of a remotely located client (13 client 1), the location of the Presence may be manually specified by any method.

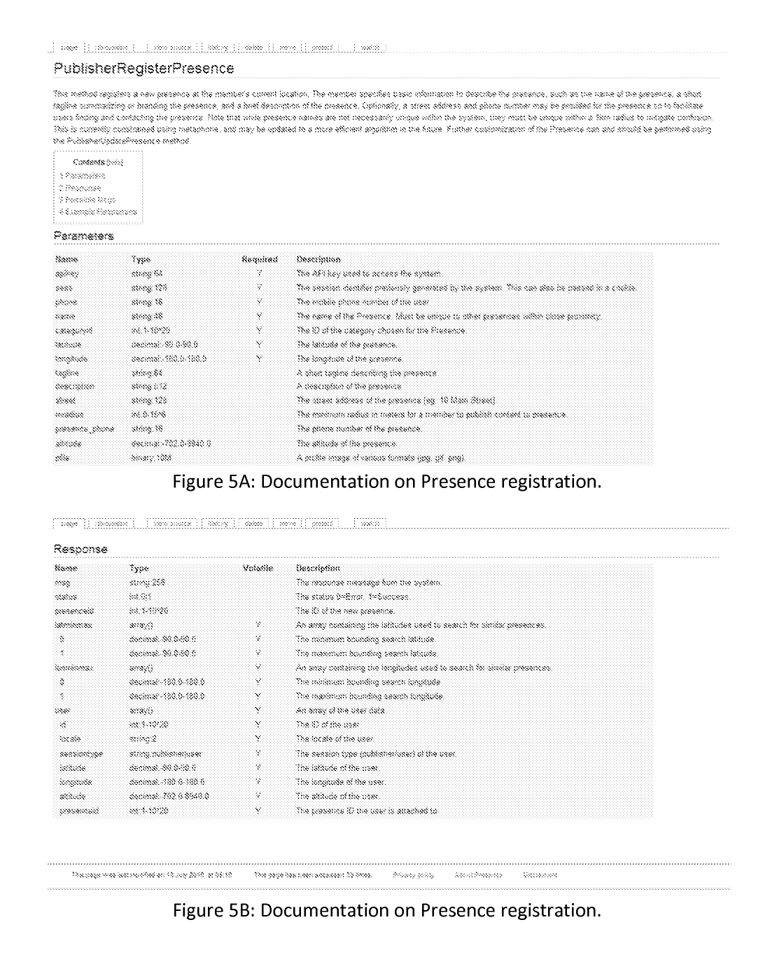

Parameters may be further specified to define the Presence such as, but not limited to, the Presence name (18), a category (19), proximity radius (17), and any other metadata (20) then sent (21) to the server (15). In accordance to the invention, and as illustrated by FIG. 5A, the server is programmed to processes the Presence registration request. In order to prevent duplicate registrations, avoid confusion for end-users and protect Presence owners against malicious registrations, the server (15) may algorithmically check if a Presence with a similar name exists nearby within any convenient radius and choose to reject the registration if duplicates are found. Upon successful registration the server (15) sends a confirmation, illustrated by FIG. 5B, which is received by the client (13).

The server (15) program associates the client (13) making the registration request with the Presence (16) and identifies the client (13) as the Presence (16) owner in subsequent request. The Presence owner may appoint other clients (13) to manage the Presence (16). The Presence may be designated as public or private. Further clients (14) may access the Presence through the server (15) based on privileges, if any.

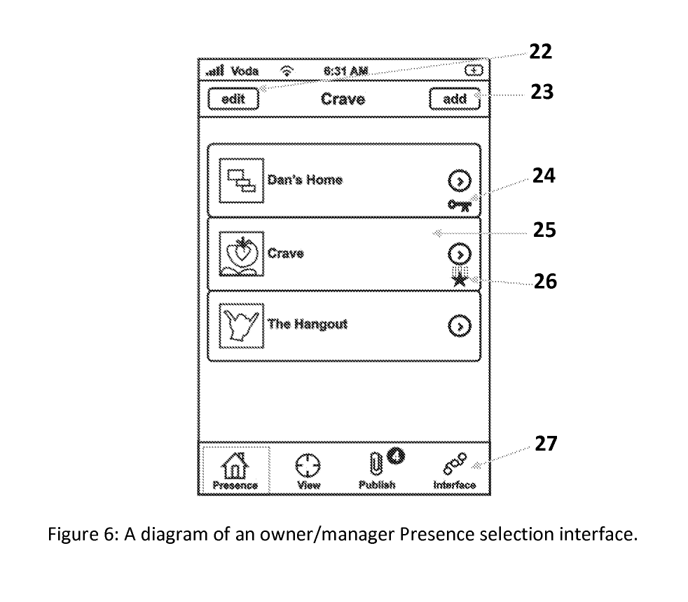

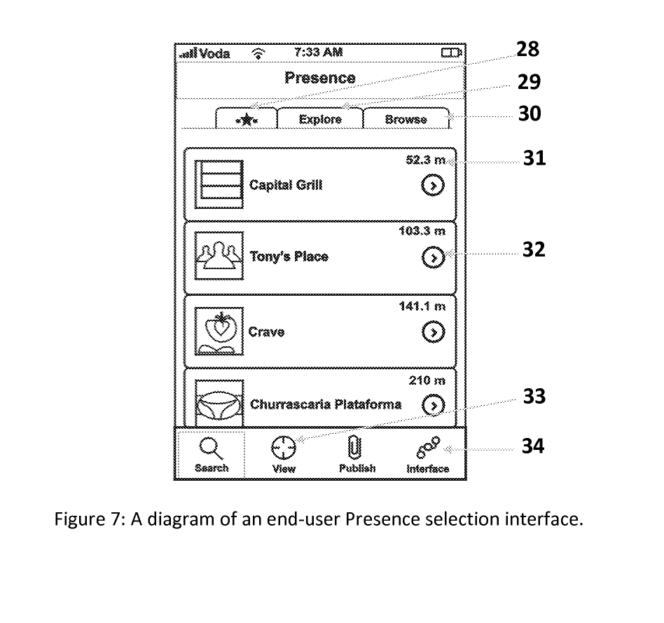

A user interface is provided, including means for allowing a client (13, 14) user to perform functions relevant to the invention and select (25, 32) a Presence as illustrated by FIG. 6 and FIG. 7. The Presence (16) may be chosen from a list of Presences filtered by any parameter. In FIG. 6, Presences are shown for which the user owns (24) or manages (26). In FIG. 7, Presences are shown filtered by category (30) and may also be filtered by keyword (29), popularity (28), preference (28), location (31), etc.

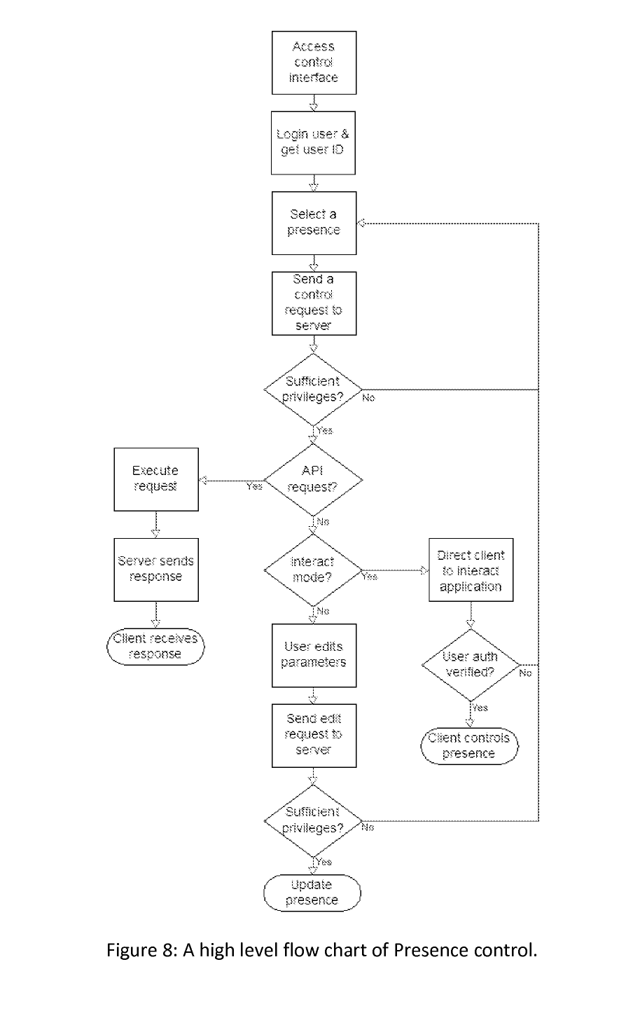

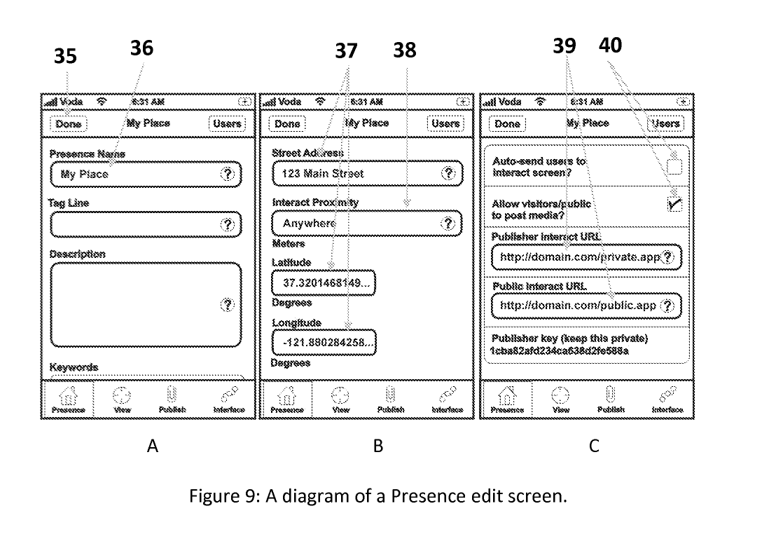

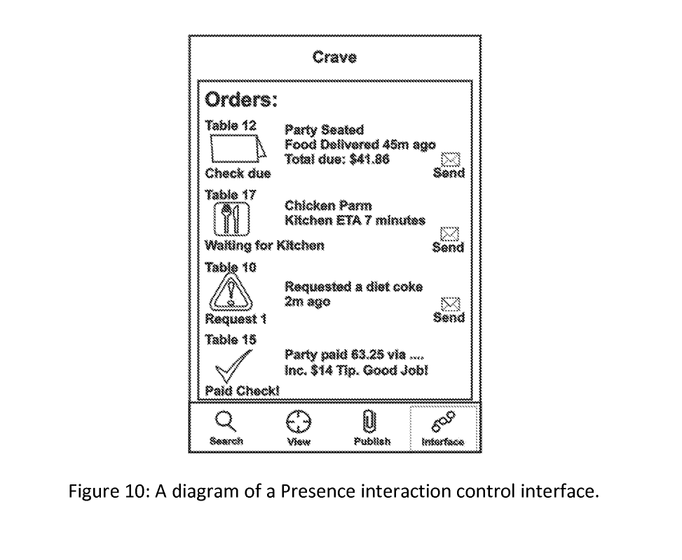

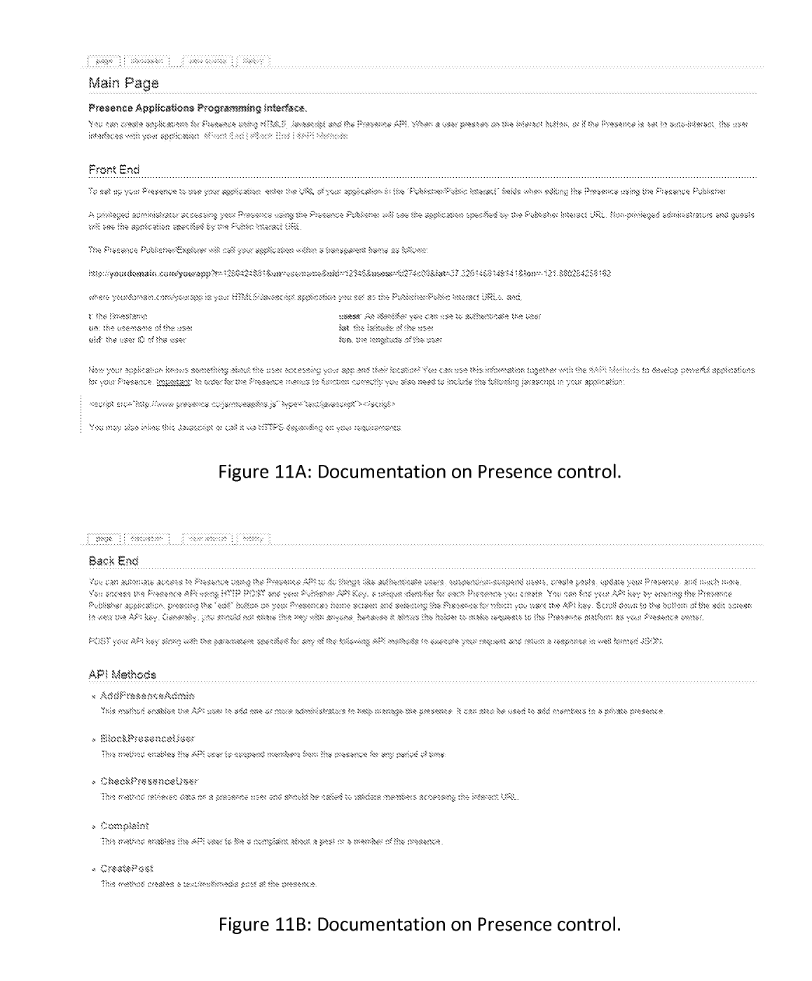

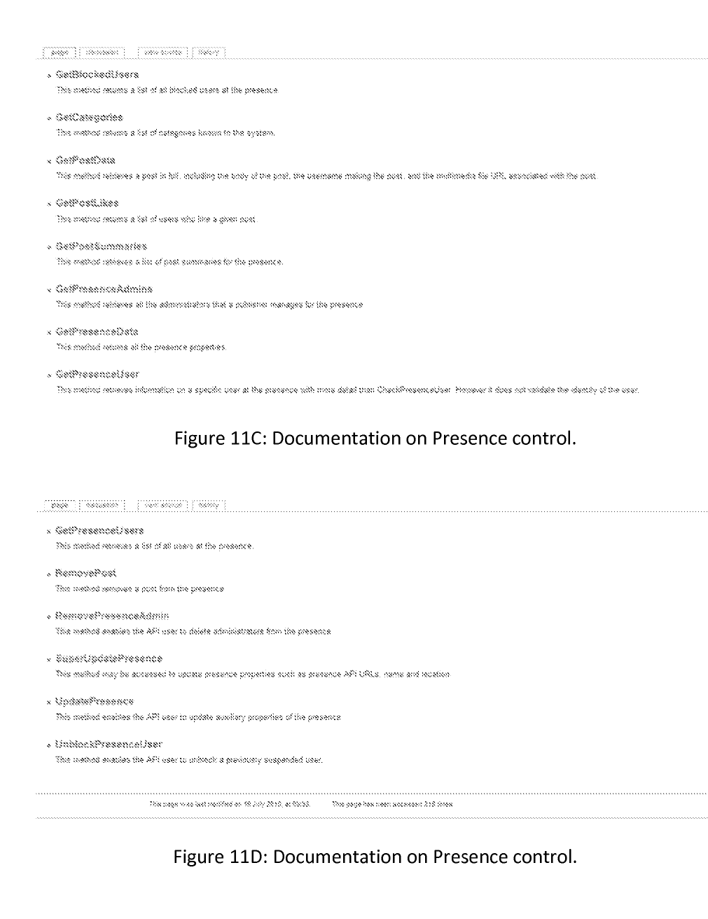

An owner or privileged manager of a Presence may edit (22) the Presence location or metadata and manage the delivery of virtual services (27); including communication with, access to, appearance of, and functionality available to end-users. FIG. 8 is a high level flowchart showing methods of managing the Presence in the preferred embodiment. FIG. 9 graphically illustrates the Presence edit screen of the control interface. FIG. 10 graphically illustrates a Presence interaction control interface. FIG. 11 graphically illustrates Presence control via an Applications Programming Interface.

A client (13) accesses the control interface to manage a Presence. The client is logged in by the server (15) and a pre-generated system user ID is obtained. The client (13) selects a Presence (25), obtains a pre-generated system Presence ID, and initiates a control request to the server (15). The server (15) determines if the client (13) has sufficient privileges with respect to the request based on the user ID/Presence ID pair. If sufficient privileges are available, and the server (15) determines that the request is an API request in accordance to the protocol and methods illustrated by FIG. 11A-D, the server (15) will execute the request and return a response indicative of the result of execution to the client (13).

If the sufficient privileges are available and the request does not conform to the API protocol, the server (15) determines whether the control request was to edit (22) the Presence (16) metadata or to interact (27) with a Presence interaction control interface. In the case that the client (13) is editing the Presence (16) metadata as illustrated in FIG. 9, the server (15) may either send the current version of metadata to the client (13) or, depending on the request, assume that the client (13) has the current metadata stored locally.

The privileged client (13) may modify any Presence (16) metadata such as, but not limited to, the name (36) of the Presence, location (37), proximity (17, 38), options (40), and URLs (39). Subsequent to modification, the client (13) sends (35) the updated metadata to the server (15) and the server (15) once again verifies the client's (13) privileges in order to update the Presence (16).

In the case that the request was to interact (27) with a Presence interaction control interface, the server (15) directs the client (13) to the pertinent resource, such as a URL (39), file, multimedia, or application representing the Presence interaction control interface. In the preferred embodiment the Presence interaction control interface is an external URL (39) served by an external application. The external application utilizes a “Check Presence User” API method as illustrated in FIG. 11B in order to ensure that the client (13) has sufficient privileges to access the Presence interaction control interface. If the client (13) has sufficient privileges, the client (13) is directed to the Presence interaction control interface in accordance with the invention.

The Presence interaction control interface is an application specific to the requirements of the Presence (16) and may utilize any programming languages, markup, multimedia, file, resource and/or leverage the API (FIG. 11) to enable virtual service management at the Presence (16) or within Presence proximity (17). An example Presence interaction control interface for a restaurant is illustrated in FIG. 10.

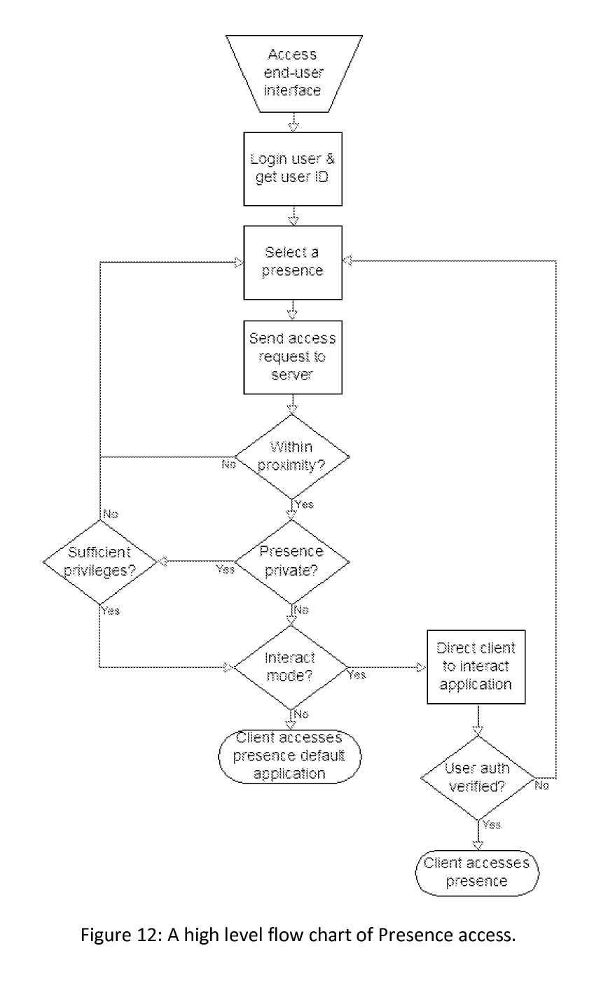

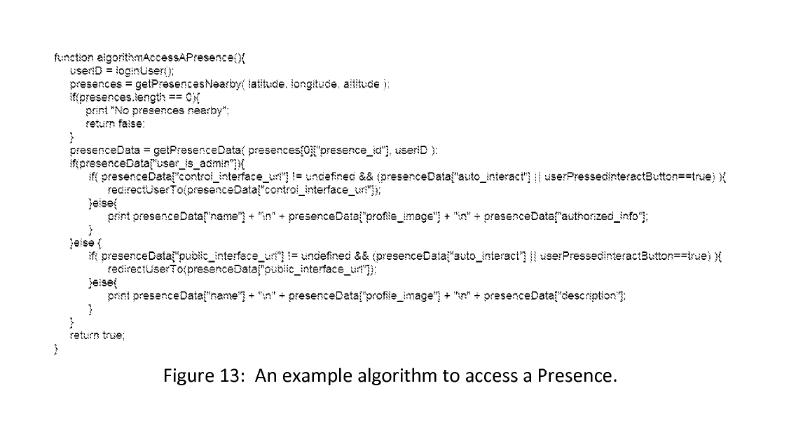

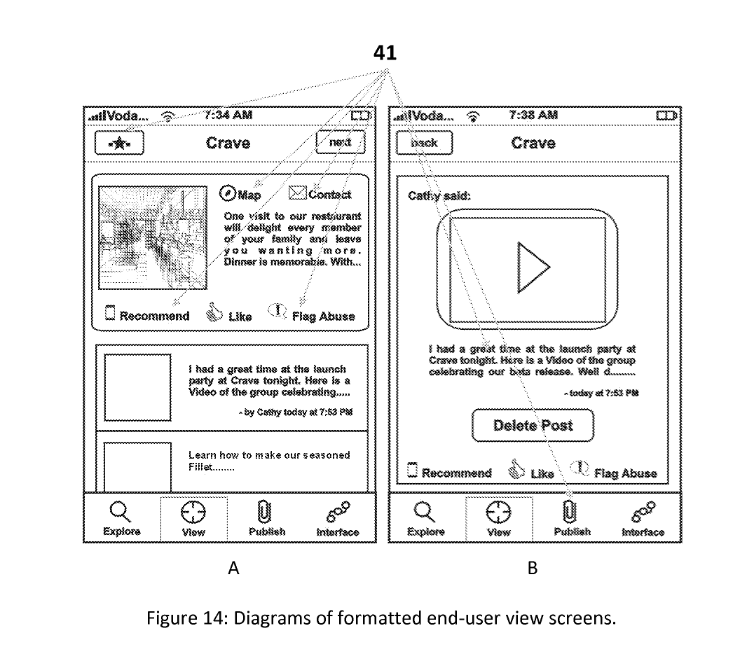

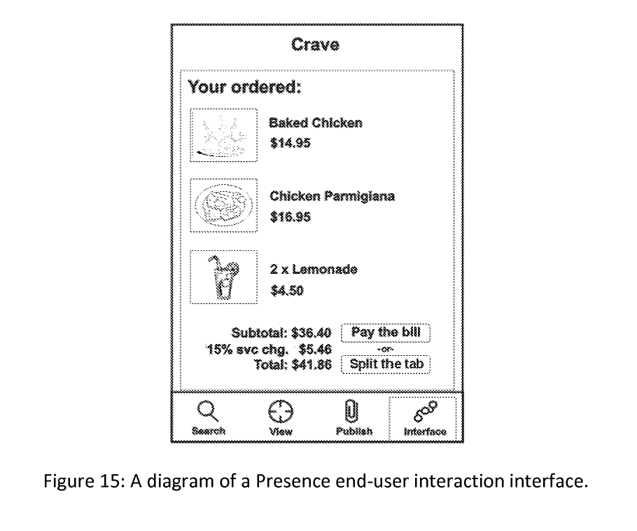

FIG. 12 is a high level flowchart showing methods of viewing or accessing the Presence as a client (14) end-user in the preferred embodiment. FIG. 13 algorithmically illustrates the flowchart in FIG. 12. FIG. 14 graphically illustrates the view screen of the Presence end-user interface. FIG. 15 graphically illustrates a Presence end-user interaction interface.

A client (14) accesses the end-user interface to view or interact with a Presence. The client is logged in by the server (15) and a pre-generated system user ID is obtained. The client (14) selects (32) a Presence, obtains a pre-generated system Presence ID, and initiates an access request to the server (15). The server (15) determines if the client (14) is within sufficient proximity (17, 38) to access the Presence (16) based in the Presence ID and the geographical coordinates obtained from the client (14) device.

The server (15) may also check Presence access options such as whether the Presence (16) is public or private and whether the client has privileges to access the Presence (16), if required, based on the user ID/Presence ID pair.

If the client (14) may access the Presence (16), the server (15) determines whether the access request was to view (33) the Presence (16) profile or to interact (34) with the Presence end-user interaction interface. In the case that the client (14) is viewing the Presence (16) profile, the client (14) may be provided with basic functionality (41) such as, but not limited to, the ability to get directions, contact the Presence, view and make posts, add to favorites, recommend the Presence, or flag abuse.

In the case that the request was to interact (34) with a Presence end-user interaction interface, the server (15) directs the client (14) to the pertinent resource, such as a URL (39), file, multimedia, or application representing the Presence end-user interaction interface. In the preferred embodiment the Presence end-user interaction interface is an external URL (39) served by an external application. The external application utilizes a “Check Presence User” API method as illustrated in FIG. 11B in order to ensure that the client (14) has sufficient privileges to access the Presence end-user interaction interface. If the client (14) has sufficient privileges, the client (14) is directed to the Presence end-user interaction interface in accordance with the invention.

The Presence end-user interaction interface is an application specific to the requirements of the Presence (16) and may utilize any programming languages, markup, multimedia, file, resource and/or leverage the API (FIG. 11) to enable virtual services to end-users at the Presence (16) or within Presence proximity (17). An example Presence end-user interaction interface for a restaurant is illustrated in FIG. 15.

Other embodiments of the present invention include, but are not limited to: pharmacy services that may provide ETA to medication pickup; medical services that may provide patient or appointment information, buildings that may provide an interface to a smart lock to authorize entry, Malls or amusement parks that may enable interactive directories, residences that may share personal data, and businesses that may implement local payment applications for their products or services.

While the preferred embodiments of the present invention have been illustrated in detail, it should be apparent that modifications and adaptations to those embodiments may occur to one skilled in the art without departing from the scope of the present invention as set forth in the following claims. This application claims priority from U.S. Provisional Application Ser. No. 61/369,773 filed on Aug. 2, 2010, the entirety of which is herein incorporated by reference.

1. A method for enabling places and objects with virtual services, comprising: electronically registering a geographical location to a user of a software application; determining or otherwise assuming that a user is the owner of the registered geographical location; using an application to electronically make access to services, provided by the owner, available to other users in proximity to the geographical location.

2. The method of claim 1, wherein the location includes global positioning system information.

3. The method of claim 1 wherein registering also includes collecting metadata from the user on the location being registered.

4. The method of claim 1 wherein the owner also includes affiliates of the owner.

5. The method of claim 1 where proximity is any distance from 1 millimeter to 50,000 kilometers.

6. The method of claim 1, wherein the application runs on a desktop computer.

7. The method of claim 1, wherein the application runs on a laptop computer.

8. The method of claim 1, wherein the application runs on a mobile device.

9. The method of claim 1, wherein the application runs on a smart-phone.

10. A method for selecting content sources for geographical locations, comprising: a server that maintains a mapping between geographical locations and URLs to be accessed over an electronic network; receiving a request that identifies one or more specific locations; providing a response consisting of one or more URLs to content associated with the requested location.

11. The method of claim 10, wherein the location includes global positioning system information.

12. The method of claim 10, wherein the URL is an IP address.

13. The method of claim 10, wherein receiving a request also entails receiving location information from an application, providing a list of locations to the application, and receiving a subset of the list.

14. The method of claim 10 wherein the content is an application.

15. The method of claim 10, wherein the application runs on a desktop computer.

16. The method of claim 10, wherein the application runs on a mobile device.

17. The method of claim 10, wherein the application runs on a laptop computer.

18. The method of claim 10, wherein the application runs on a smart-phone.

19. A method for controlling access to content made available over electronic networks comprising the steps of: maintaining a mapping between geographical locations and relative allowable interaction proximities; receiving a request to access content associated with the geographic location; determining, based on identifying information, the proximity of the requestor to the geographical location; controlling access to content based on a comparison between requestor proximity and location specific interaction proximity.

20. The method of claim 19, wherein the geographical locations include global positioning system information.

21. The method of claim 19, wherein the location owner is the owner of the registered geographical location in claim 4.

22. The method of claim 19, wherein the request to access content includes user location information.

23. The method of claim 22, wherein location information includes global positioning system information.

24. The method of claim 19, wherein the requestor includes the user on behalf of whom the request is being made.

25. The method of claim 19, wherein controlling access is includes permitting access.

26. The method of claim 25, wherein permitting includes communicating information that signifies whether access should be permitted.

27. The method of claim 19, wherein controlling access is includes denying access.

28. The method of claim 27, wherein denying includes communicating information that signifies whether access should be denied.

29. A method for delivering location specific virtual services to a mobile device. The method comprising: A mobile device sends location identifying information and session identifying information to a server; the server cross references a mapping between location identifying information and content sources; the server facilitates interaction between the user of the mobile device and the location.

30. The method of claim 29, wherein the location is a business establishment.

31. The method of claim 29, wherein the location is an organization.

32. The method of claim 29, wherein the location is a machine capable of interaction.

33. The method of claim 29, wherein the location is mobile.

34. The method of claim 29, wherein the location identifying information includes a unique identifier, global positioning system information

35. The method of claim 29, wherein the location identifying information includes a location name.

36. The method of claim 29, wherein the location identifying information includes a keyword.

37. The method of claim 29, wherein the location identifying information includes a phone number.

38. The method of claim 29, wherein the session includes a unique identifier, username, phone number or keyword.

39. The method of claim 29, wherein the content source is a software application, source code or executable code.

40. The method of claim 29, wherein the server is a plurality of servers.

41. A system for enabling locations with virtual services in a multi-processing/multi-programming computing environment, comprising:
one or more owner client computing device controlled by owners or affiliates of the location;
one or more visitor client computing device controlled by visitors to the location;
one or more server computing devices;
a communication link interconnecting said client and server devices;
data communication means in the owner client device for sending location and session identifying information to the server device;
logical and storage means in the server device to designate the owner client session as the location owner;
programmatic content means on the server device making access to services available on behalf of the owner client available to visitor clients in geographical proximity to the location.

42. A system for selecting content sources for geographical locations in a multi-processing/multi-programming computing environment, comprising:
one or more client computing devices;
one or more server computing devices;
a communication link interconnecting said client and server devices;
storage means in the server device containing a mapping between geographical locations and URLs;
request receiving means in the server to parse geographical location identifying information from the client;
comparison means in the server to retrieve one or more URLs associated with said client request;
response sending means in the server to provide said URLs to the client;
request receiving means in the client to receive said response and provision content associated with the location.

43. A system for controlling access to content made available over electronic networks, in a multi-processing/multi-programming computing environment, comprising:
one or more client computing devices;
one or more server computing devices;
a communication link interconnecting said client and server devices;
input means in the client device for specifying target location;
storage means in the server device containing a mapping between target; geographical locations and relative allowable interaction proximities;
request receiving means in the server to parse client geographical location; identifying information and target location identifying information from the client;
comparison means in the server to retrieve target location geographical information associated with said client request;
arithmetic means in the server to determine the proximity of the client device to the target geographical location;
comparison means in the server to determine if said client proximity is within target location allowable interaction proximity.

44. A system for delivering virtual services associated with a location, in a multi-processing/multi-programming computing environment, comprising:
one or more client computing devices;
one or more server computing devices;
a communication link interconnecting said client and server devices;
input means in the client device for specifying target location;
storage means in the server device containing a mapping between target geographical locations and content;
request receiving means in the server to parse location and session identifying information from the client;
comparison means in the server to retrieve content associated with said client request;
programmatic means on the server for facilitating an interaction between the client and the location based on said content.

45. One or more processor readable storage devices having processor readable code embodied on said processor readable storage devices, said processor readable code for programming one or more processors to perform a method of enabling places and objects with virtual services, comprising the steps of:
electronically registering a geographical location to a user of a software application; and
determining or otherwise assuming that a user is the owner of the registered geographical location; and
using an application to electronically make access to services, provided by the owner, available to other users in proximity to the geographical location.

46. One or more processor readable storage devices having processor readable code embodied on said processor readable storage devices, said processor readable code for programming one or more processors to perform a method of selecting content sources for geographical locations, comprising the steps of:
maintaining a mapping between geographical locations and URLs to be accessed over an electronic network; and
receiving a request that identifies one or more specific locations; and
providing a response consisting of one or more URLs to content associated with the requested location.

47. One or more processor readable storage devices having processor readable code embodied on said processor readable storage devices, said processor readable code for programming one or more processors to perform a method of controlling access to content made available over electronic networks comprising the steps of:
maintaining a mapping between geographical locations and relative allowable interaction proximities; and
receiving a request to access content associated with the geographic location; and
determining, based on identifying information, the proximity of the requestor to the geographical location; and
controlling access to content based on a comparison between requestor proximity and location specific interaction proximity.

48. One or more processor readable storage devices having processor readable code embodied on said processor readable storage devices, said processor readable code for programming one or more processors to perform a method of delivering location specific virtual services to one or more processors comprising the steps of:
sending location and session identifying information to a remote server; and
cross referencing a mapping between location identifying information and content sources; and
facilitating an interaction between the sender of the location and session identifying information and the location.
